(19) United States
(12) Patent Application Publication
(10) Pub. No.: US 2012/0206089 A1
(43) Pub. Date: Aug. 16, 2012

(54) Advertising Device with Charging Base

(76) Inventor: Mark LoBianco, Lindenhurst, NY (US)

(21) Appl. No.: 13/024,599

(22) Filed: Feb. 10, 2011

(51) Int. Cl. H02J 7/00

(52) U.S. Cl. 320/107

(57) ABSTRACT

An advertising device, having a charging base for charging multiple various electronic devices is provided. The advertising device includes a three dimensional advertising member; a base member configured for supporting the advertising member; a plurality of charging connectors disposed along the periphery of the base member; an illumination source disposed at an internal position of the base member; and a power distribution assembly for providing power to the illumination source and the plurality of charging connectors. In addition, the advertising device includes a notifying unit and a receiver fob associated with each charging connector.

### FIELD OF THE INVENTION

The present invention relates generally to advertising signage. More specifically, the present invention relates to a device providing a three-dimensional product advertisement and a charging station base adapted for charging electronic devices.

### BACKGROUND OF THE DISCLOSURE

Society is becoming increasingly dependent on various portable electronic devices ranging from mobile telephones and PDAs to laptop and tablet computers. However, the heavy reliance on these devices often leads to a short battery life because the active usage of the device depletes the battery charge more rapidly than when the device is in a standby, or inactive mode.

Consequently, a readily available means of recharging the various electronic devices while away from home is needed. Large kiosks that provide charging of electronic devices for a fee are commonly available at airports and other such facilities. However, such large kiosks are unattractive and occupy a significant amount of floor space. As a result these kiosks are not generally installed in such establishments as restaurants, bars and night clubs.

### SUMMARY OF THE DISCLOSURE

An advertising device, in accordance with the present invention, includes an advertising member having a three-dimensional aspect; a base member configured for supporting the advertising member; a plurality of charging connectors disposed along the periphery of the base member; an illumination source disposed at an internal position of the base member; and a power distribution assembly for providing power to the illumination source and the plurality of charging connectors.

Additionally, an embodiment of the present invention includes a notifying unit for providing a notification of a charge state of an associated device when the associated device is fully charged. The notifying unit includes a remote notification device for providing notification of the state of charge, by way of a radiofrequency (RF) transmission received from the notifying unit, directly to an owner of the associated device.

### BRIEF DESCRIPTION OF THE DRAWINGS

These and other features, aspects, and advantages of the present invention will become better understood with regard to the following description, appended claims, and accompanying drawings wherein:

FIG. 1 illustrates an embodiment of the present invention;

FIG. 2 illustrates a block representation of an embodiment of the present invention; and

FIGS. 3-5 illustrate various alternative embodiments of the present invention.

### DETAILED DESCRIPTION OF DISCLOSURE

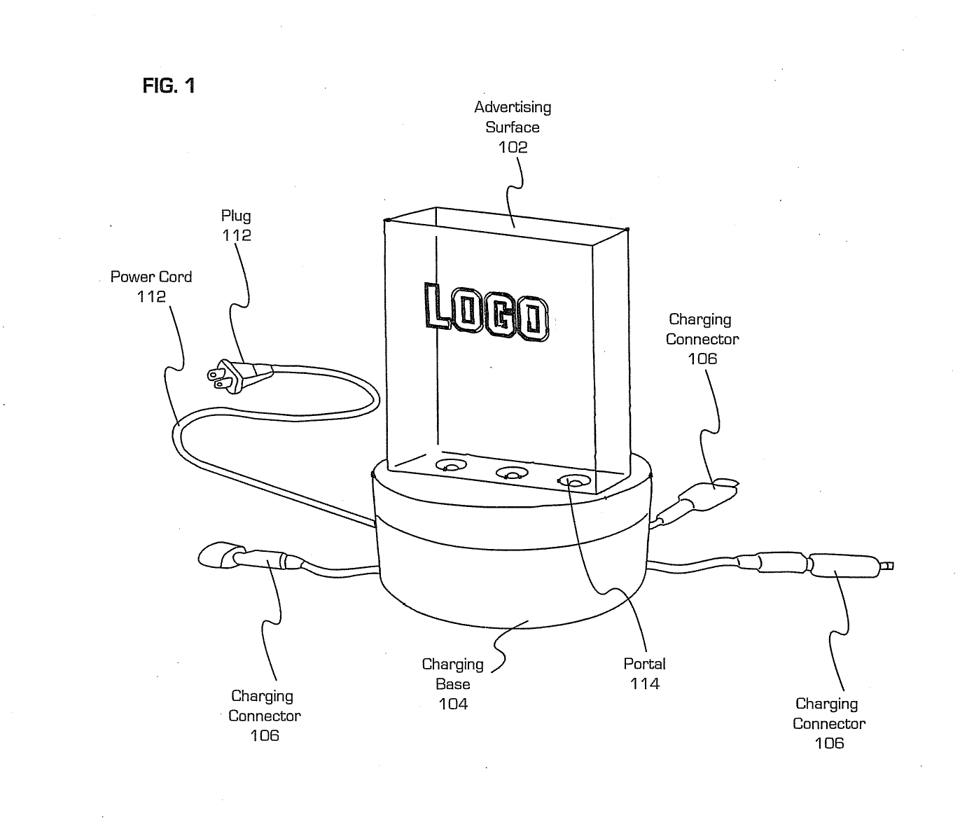

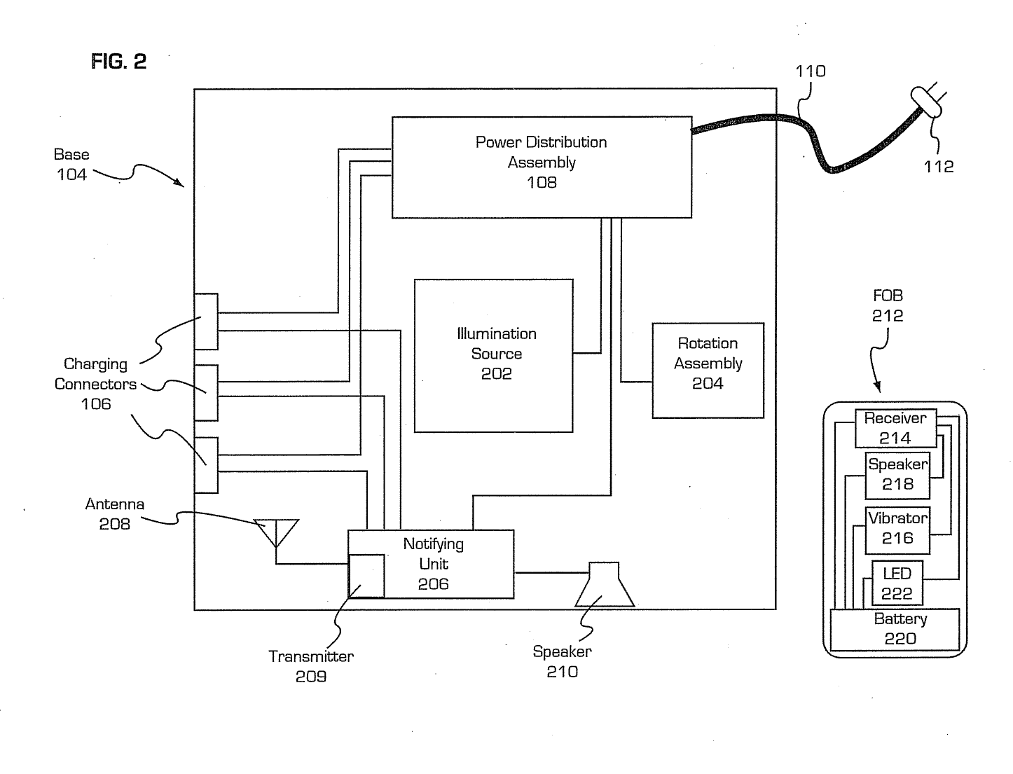

Referring to FIG. 1 and FIG. 2, an embodiment of the present invention includes a three dimensional advertising surface 102 disposed on a charging base 104. The charging base 104 can be any shape and size that accommodates the necessary internal components and provides a stable support for the three dimensional advertising surface 102. In addition, the charging base 104 has a plurality of charging connectors 106 through which a plurality of different types of electronic devices (not shown) can be removably connected to a power distribution unit 108 for charging of the connected electronic devices.

As shown in FIG. 2, the power distribution unit 108 is enclosed in the charging base 104 and provides charging power to the plurality of charging connectors 106, as well as operating power to various optional components, described below, of the charging base 104. The power distribution unit 108 is equipped with a power cord 110 and plug 112 adapted for insertion into a standard AC power outlets of the type commonly installed in residential and commercial structures. Additionally, the power distribution unit 108 transforms the input AC power to one or more DC voltages suitable for charging electronic devices, such as laptops, mobile phones, PDAs, and tablets.

An embodiment of the present invention, as shown in FIG. 2, includes an illumination source 202 disposed to illuminate the three dimensional advertising surface 102. In the case where the three dimensional advertising surface 102 is constructed of a transparent or translucent material, the illumination source 202 is preferably positioned to radiate light through one or more portals 114 formed on the top surface of the charging base 104. In the case where the three dimensional advertising surface 102 is constructed of opaque material, the illumination source 202 is adapted to reflect light off the surface of the three dimensional advertising surface 102. Alternatively, in cases where at least portions of the three dimensional advertising surface 102 is constructed of transparent or translucent material, the illumination source 202 is adapted to transmit light through the three dimensional advertising surface 102 to radiate out of the trans parent or translucent portions.

Additionally, an embodiment of the present invention, a rotation assembly 204, mechanically coupled to the three dimensional advertising surface 102, is disposed within the charging base 104. The rotation assembly 204 is powered by an output of the power distribution unit 108. The rotation assembly 204 may be coupled to the three dimensional advertising surface 102 by a gear assembly or pulley system (not shown) in order to rotate the three dimensional advertising surface 102 around a vertical axis of the three dimensional advertising surface 102. The rotational assembly may utilize a DC motor, a stepper motor, or servo motor to provide the necessary rotational force to the three dimensional advertising surface 102.

Further, an embodiment of the present invention may include a notifying unit 206. The notifying unit 206 provides notification when an electronic device connected to one of the charging connectors 106 is fully charged. In one embodiment, the notifying unit is equipped with a speaker which emits an audible signal when the electronic device is charged.

Alternatively, a display may be provided as the notifying unit 206 that shows the charge status of each electronic device being charged. The notifying unit 206, in this case, may be an OLED display, an LCD display, and/or a plurality of color LEDs.

A further embodiment of the notifying unit 206 includes a radiofrequency transmitter 209 coupled to an antenna 208. In addition, a remote notification device (i.e., receiver fob 212) corresponding to each of the charging connectors 106 is provided. Each receiver fob 212 is individually addressable by the notifying unit 206. The receiver fob 212 is equipped with a receiving antenna 214, a vibrator 216, a light source 222, and/or a speaker 218 that are activated by a signal received from the notifying unit 206. The signal is sent in response to the electronic device connected to the charging connector 106 associated with the individual receiver fob 212 having been fully charged. A battery 220 in the receiver fob 212 provides the necessary power to operate the various components of the receiver fob 212. Additionally, the battery 220 is rechargeable, preferably by the charging connectors 106.

Moreover, the receiver fob 212 may be activated when the person in possession thereof exits a defined area, where the defined area is determined by a received signal strength. In this way, the receiver fob 212 provides a notification to the owner of the associated electronic device when the electronic device is charged; and a reminder that the owner of the associated electronic device has left the defined area without reclaiming the electronic device from the present invention.

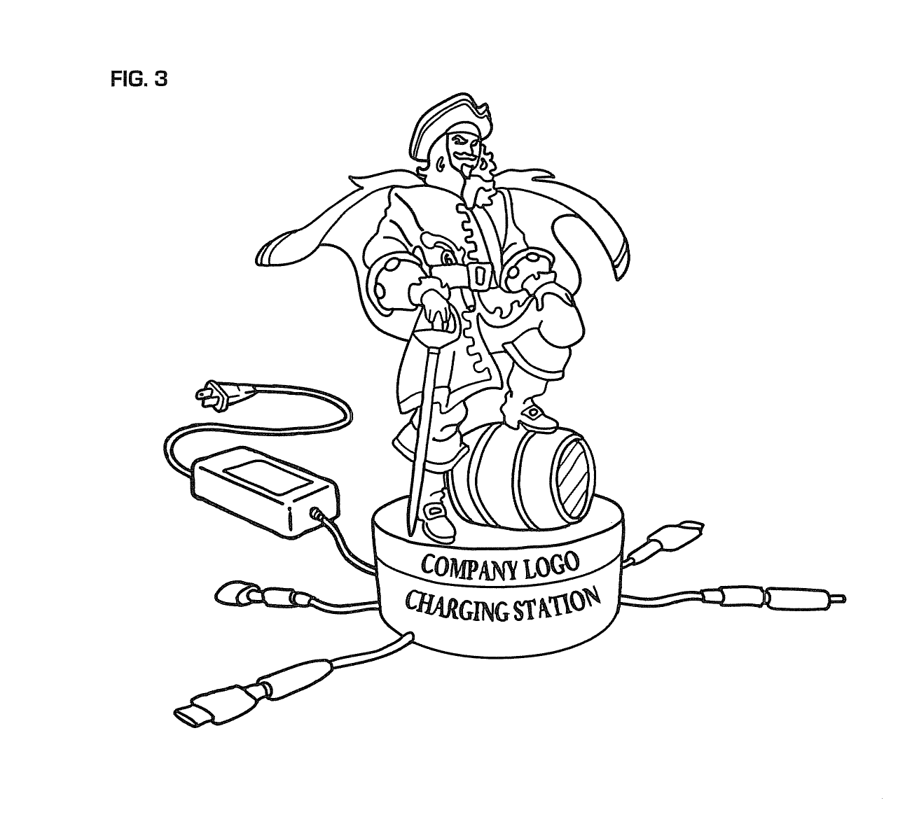

The present invention, as described above provides a charging station for electronic devices. The charging station is uniquely adapted for installation at bars, restaurants and night clubs. The three dimensional advertising surface 102 allows for various types of advertising to be presented to patrons at these types of establishments. For example, FIG. 3-5 shows various designs for the three dimensional advertising surface 102.

As shown in FIG. 3, the three dimensional advertising surface 102 can be formed as an iconic mascot of a particular brand, such as the pirate representing Captain Morgan™ rum depicted in. FIG. 3. Alternatively, a school or team mascot may be used as the three dimensional advertising surface 102. In yet another alternative, the three dimensional advertising surface 102 can be formed into a corporate logo, insignia, or other graphic representative of an organization. The present invention as shown in FIG. 3 can be placed, for example, on a shelf behind a bar, etc.

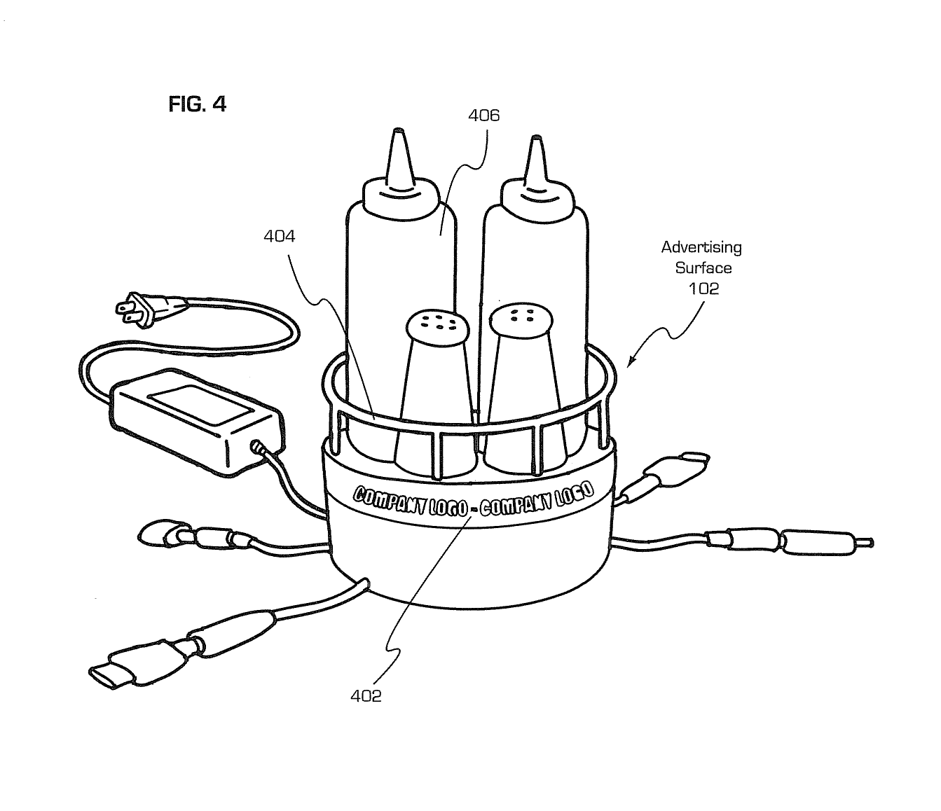

In FIG. 4, the three dimensional advertising surface 102 can be fashioned into a dual-use surface. For example, as shown in FIG. 4 a portion 402 of the three dimensional advertising surface 102 can be allocated for displaying a company logo or other advertisement, while a second portion 404 may be allocated to hold, for example, condiments 406.

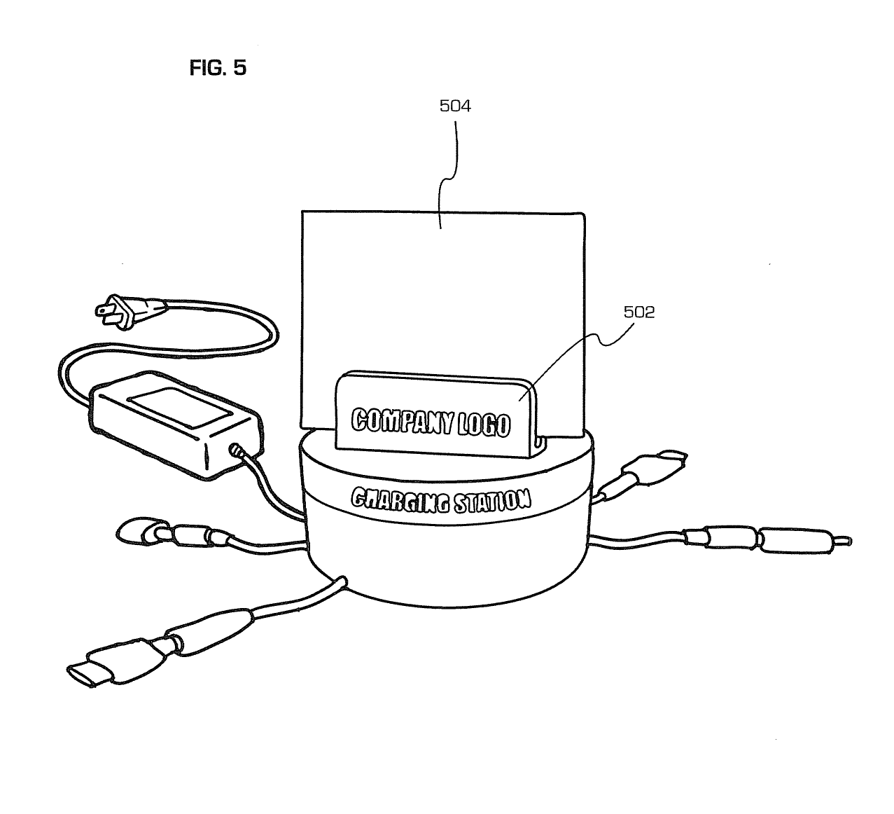

Alternatively, the second portion 404 can be formed as a card holder 502, as shown in FIG. 5. The card holder can be used to hold a bar or specials menu 504, for example. In the case of the embodiments shown in FIGS. 4 and 5, the present invention can be placed on individual tables or along a countertop accessible by patrons.

The described embodiments of the present invention are intended to be illustrative rather than restrictive, and are not intended to represent every embodiment of the present invention. Various modifications and variations can be made without departing from the spirit or scope of the invention as set forth in the following claims both literally and in equivalents recognized in law.

What is claimed is:

1. An advertising device comprising:
An advertising member having a three-dimensional aspect;
a base member configured for supporting the advertising member;
a plurality of charging connectors disposed along the periphery of the base member; and
a power distribution assembly for providing power to the illumination source and the plurality of charging connectors.

2. The advertising device as in claim 1, further comprising an illumination source disposed at an internal position of the base member.

3. The advertising device as in claim 2, wherein the base member further comprises a portal through which light from the illumination source radiates into the translucent advertising member.

4. The advertising device as in claim 1, wherein the advertising member is a three-dimensional representation of a logo.

5. The advertising device as in claim 1, wherein the advertising member is a three-dimensional representation of a mascot.

6. The advertising device as in claim 1, wherein the power distribution assembly provides selectable charge voltages for each of the plurality of charging connectors.

7. The advertising device as in claim 1, wherein the plurality of charging connectors have changeable connector tips adapted to connect with multiple portable devices.

8. The advertising device as in claim 1, further comprising a notifying unit for providing a notification of a charge state of an associated device when the associated device is fully charged.

9. The advertising device as in claim 8, wherein the notifying unit includes a remote notification device for providing notification of the state of charge directly to an owner of the associated device.

10. The advertising device as in claim 9, wherein the remote notification device has an RF receiver and the base member has a transmitter with a communication range limited to a defined area.

11. The advertising device as in claim 9, wherein the remote notification device is a plurality of remote notification devices, each remote notification device is associated with a respective one of the plurality of charging connectors.

12. The advertising device as in claim 9, wherein the remote notification device emits a vibration and/or sound when the associated device is fully charged.

13. The advertising device as in claim 1, further comprising a rotation assembly for rotating the advertising member at a predetermined rate and direction.
